(19) United States
(12) Patent Application Publication
(10) Pub. No.: US 2019/0383392 A1
(43) Pub. Date: Dec. 19, 2019

(54) UNLOCKING DEVICE FOR UNLOCKING A PARK LOCK OF A VEHICLE AND METHOD FOR OPERATING AN UNLOCKING DEVICE

(71) Applicant: ZF Friedrichshafen AG, Friedrichshafen (DE)

(72) Inventors: Joachim SPRATTE, Osnabrueck (DE); Torsten AUMANN, Drentwede (DE)

(73) Assignee: ZF Friedrichshafen AG, Friedrichshafen (DE)

(21) Appl. No.: 16/463,731

(22) PCT Filed: Oct. 24, 2017
(86) PCT No.: PCT/EP2017/077046

§ 371 Date: May 23, 2019

(30) Foreign Application Priority Data
Nov. 28, 2016 (DE) 10 2016 223 560.5

(51) Int. Cl. F16H 63/34; B60T 1/00

(52) U.S. Cl. CPC F16H 63/3491; B60T 1/005

(57) ABSTRACT

The present approach relates to an unlocking device (105) for unlocking a park lock (110) of a vehicle (100). The unlocking device (105) comprises at least an eccentric apparatus (115), a slide unit (120) and an actuation apparatus (125). The eccentric apparatus (115) is designed to hold the slide unit (120) in a locking position in which the park lock (110) is locked or engaged in a first position in which the eccentric apparatus (115) is accommodated at least partly in the slide unit (120), and in a second position, to enable a transfer of the slide unit (120) into an unlocking position, in which the park lock (110) is unlocked or disengaged. The slide unit (120) is or can be coupled to the park lock (110) via a transmission element (155) and is designed, in the locking position, to position the transmission element (155) in a park locking position in order to lock the park lock (110) and in the unlocking position, to position the transmission element (155) in a park unlocking position in order to lock the park lock (110). The actuation apparatus (125) is designed to move the eccentric apparatus (115) from the first position to the second position in response to an actuation.

The following approach relates to an unlocking device for unlocking a park lock of a vehicle and a method for operating an unlocking device.

If a gear selector level is at “P” for automatic transmissions of a vehicle, a park lock is engaged and prevents the vehicle from rolling away. The park lock can be controlled by a cable of the gear selector lever. For some automatic transmissions the engagement and disengagement takes place via an internal hydraulic pilot control. For some transmissions the actuation also takes place via electric motors. In the case of these transmissions, an electric motor actuates the park lock via a gear box and in this way secures the vehicle from rolling away.

Against this background, the present approach creates an improved unlocking device for unlocking a park lock of a vehicle and an improved method for operating an unlocking device in accordance with the main claims. Advantageous embodiments arise from the subsidiary claims and the subsequent description.

According to the approach presented here an unlocking device for unlocking a park lock of a vehicle comprises at least an eccentric apparatus, a slide unit and an actuation apparatus. The eccentric apparatus is designed in a first position, in which the eccentric apparatus is accommodated at least partly in the slide unit, to hold the slide unit in a locking position, in which the park lock is locked or engaged and, in a second position, to enable a transfer of the slide unit into an unlocking position, in which the park lock is unlocked or disengaged. In this connection, the slide unit can continue to be accommodated at least partly in the slide unit or no longer be accommodated in the slide unit. The slide unit is or can be coupled to the park lock via a transmission element, in particular a cable and is designed, in the locking position, to position the transmission element in a park locking position, in order to lock the park lock and in the unlocking position to position the transmission element in a park unlocking position, in order to unlock the park lock. The actuation apparatus is designed to move the eccentric apparatus from the first position to the second position in response to actuation. To this end, the actuation apparatus can for example be arranged on the gear selector lever or in the region of the gear selector lever of the vehicle, since the actuation apparatus is easily accessible for a user here.

An unlocking device presented here makes it possible to unlock the park lock currentlessly and by hand with only one transmission element already present in a switching device of the vehicle such as for example a cable. This can be advantageous when a defective vehicle needs to be removed from a park position,

A section of the eccentric apparatus accommodated in the slide unit can be designed to execute a linear movement along an eccentric axis device of the eccentric apparatus in response to actuation. Thus, the section can be moved along the eccentric axis device from the first position to the second position. In so doing, the section can be accommodated in a through opening of the slide unit in the first position of the eccentric apparatus and in the second position of the eccentric apparatus be partly moved out of the through opening or also be completely moved out of the through opening.

According to one embodiment, the section of the eccentric apparatus can have an offset element, which is designed to limit a lateral movement of the slide unit running perpendicular to the linear movement in response to the linear movement of the eccentric apparatus, when the eccentric apparatus according to one embodiment is also arranged at least partly in the slide unit in the second position. The offset element can in so doing advantageously form a stepped elevation of the section, which is designed to limit the lateral movement of the slide unit in a form-fitting manner in the second position of the eccentric apparatus. Thus, the slide unit can be arranged contiguously to the offset element in the second position of the eccentric apparatus.

To limit the movement of the eccentric apparatus, e.g. the linear movement, the eccentric apparatus, for example the eccentric axis device can have at least one compression spring which is relaxed in the first position of the eccentric apparatus and which is arranged to be tensioned in response to actuation by at least one component of the eccentric apparatus, for example by the section. Such a compression spring can in addition enable an eased movement of the component from the second position back to the first position.

According to one advantageous embodiment, the unlocking device can have a transfer device, which is designed to transfer the slide unit from the locking position to the unlocking position. In so doing, the transfer device can enable a gentle transfer of the slide unit from the locking position to the unlocking position, in which for example a wear and tear of the offset element can be prevented. To this end, the transfer device has at least one support spring, which is arranged in the locking position of the slide unit to exert a pretensioning on the slide unit and/or a lever device of the transfer device, wherein the support spring is arranged, in response to the movement of the eccentric apparatus to the second position, to release the pretensioning, in order to enable a transfer of the slide unit to the unlocking position.

It is furthermore of advantage if the transfer device has in addition at least the lever device, which can be designed to be turned in response to a release of the pretensioning of the support spring, in order to gently shift the slide unit to the unlocking position.

In order to prevent the transfer of the slide unit from the locking position to the unlocking position, as long as the eccentric apparatus is arranged in the first position, the transfer device can have at least one hook device with at least one hook, which, in the first position of the eccentric apparatus is coupled to the lever device such that a turning of the lever device is prevented in a form-fitting manner. Furthermore, the hook device can be arranged to be deflected through the movement of the eccentric apparatus to the second position by the eccentric apparatus, for example by the section, such that the hook releases the lever device and the lever device, driven by the support spring, is turned.

According to one embodiment, the unlocking device can have a sensor device, which has at least one eccentric sensor device arranged on the eccentric apparatus and/or a slide sensor device arranged on the slide unit. The sensor device can be designed advantageously to detect at least one position of the eccentric apparatus accommodated in the slide unit or in the region of the slide unit. Here the position can represent the second position of the eccentric apparatus. Thus, the sensor can be designed to at least detect whether the park lock is unlocked.

In this connection, the sensor device can be designed to compare an eccentric sensor position of an eccentric sensor of the eccentric sensor device and/or a slide sensor position of a slide sensor of the slide sensor device, in order to detect the position. For example, this can be enabled when the eccentric sensor position is assigned to a slide sensor position, in particular wherein the position can be detected when the eccentric sensor position is not arranged in a predetermined relationship to the assigned slide sensor position. In so doing, for example an eccentric sensor position R1 can be assigned to a slide sensor position R, which corresponds to a gear selector lever position of a gear selector lever of the vehicle in a gear R. In this connection, the eccentric sensor position RI can be arranged in the region of the first position of the eccentric unit. The eccentric sensor position is accordingly not arranged in the predetermined relationship to the slide sensor position if the eccentric apparatus has been moved to the second position. Thus, it is possible to quickly and easily detect that the park lock is unlocked by the unlocking device.

The eccentric sensor device can have a plurality of eccentric sensors, which are arranged in the shape of an arc, for example on the section and/or the slide sensor device can have a plurality of slide sensors, which are linearly arranged. An arc-shaped arrangement of the eccentric sensors can be understood as an arrangement of the eccentric sensors in which an element arranged on an eccentric passes over the eccentric sensors in the event of a rotation of the eccentric. Thus, further typical eccentric sensor positions can be assigned to slide sensor positions, which for example can represent further typical manual transmission settings such as e.g. P.

To counteract a wear and tear of the sensor device, it is of advantage if at least one eccentric sensor of the eccentric sensor device and/or a slide sensor of the slide sensor device is at least partly designed as a magnetic sensor. The eccentric apparatus and/or the slide unit can have at least one magnet for the detection of at least one assigned position.

It is furthermore of advantage if the unlocking device has at least one damping element, for example arranged on or in a housing of the unlocking device, that is designed to acoustically dampen at least one noise of the unlocking device in the unlocking of the park lock. To this end, the damping element can have at least one opening, which is designed to accommodate a dome of an adapter device, to which the unlocking device should be fixed. To fix the unlocking device to the adapter device the damping element can have at least one self-tapping screw, which is designed to screw into the dome of the adapter device when the damping element is accommodated by the dome.

A method for operating one of the presented unlocking devices comprises at least the following steps:
Moving the eccentric apparatus from the first position to the second position in response to the actuation of the actuation apparatus; and
Transferring the slide unit from the locking position to the unlocking position in response to the pace of the movement, in order to unlock the park lock.

The advantages of the unlocking device underlying the approach can also be implemented quickly and in a technically simply manner through the method presented here.

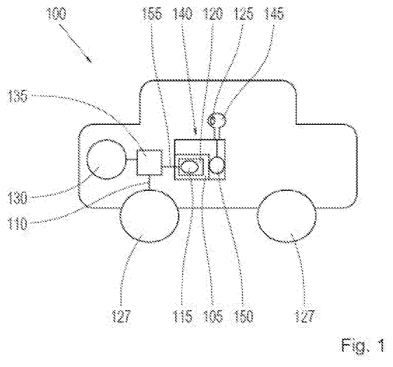

FIG. 1 shows a schematic representation of a vehicle with an unlocking device according to an exemplary embodiment;

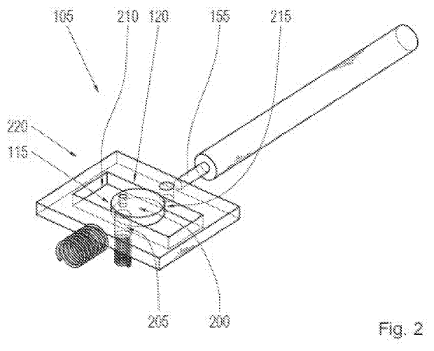

FIG. 2 shows a perspective view of an unlocking device according to an exemplary embodiment;

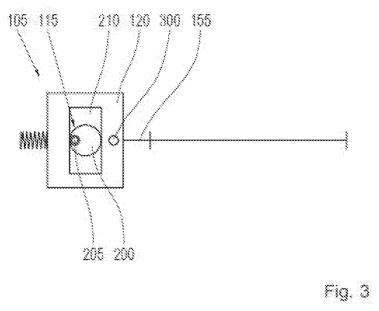

FIG. 3 shows a schematic top view of an unlocking device according to an exemplary embodiment;

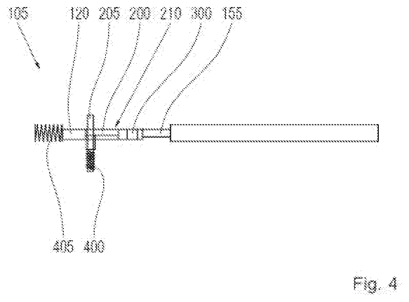

FIG. 4 shows a lateral cross-section display device according to an exemplary embodiment;

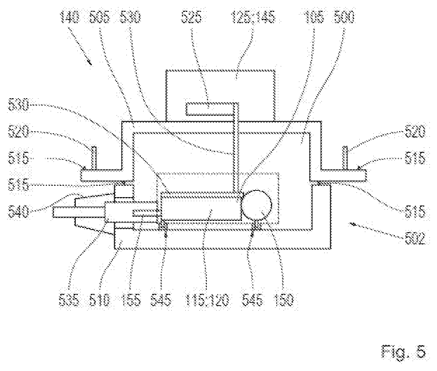

FIG. 5 shows a schematic cross-section display of a switching device with an unlocking device according to an exemplary embodiment;

FIG. 6 shows a top view of an unlocking device according to an exemplary embodiment;

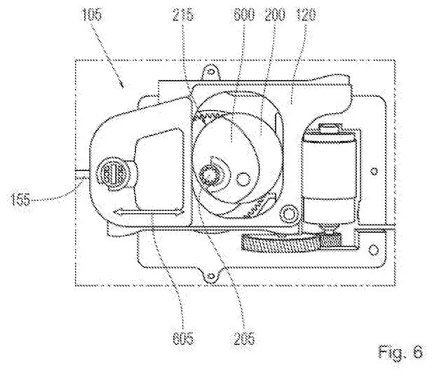

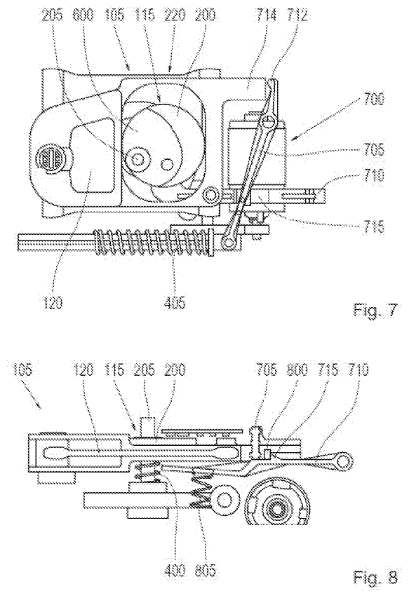

FIG. 7 shows a top view of an unlocking device according to an exemplary embodiment;

FIG. 8 shows a lateral cross-section display device according to an exemplary embodiment;

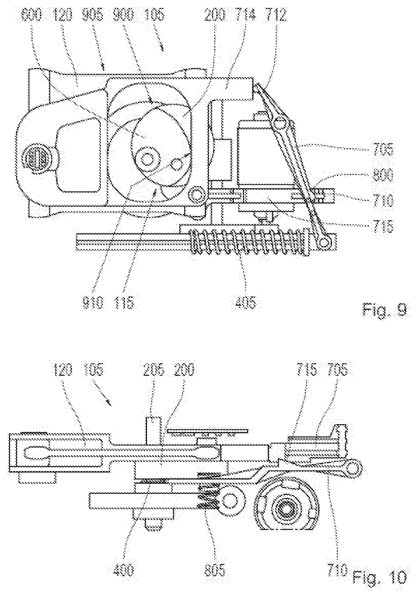

FIG. 9 shows a top view of an unlocking device according to an exemplary embodiment;

FIG. 10 shows a lateral cross-section display device according to an exemplary embodiment;

FIG. 11 shows a perspective representation of an eccentric apparatus with an offset element according to an exemplary embodiment;

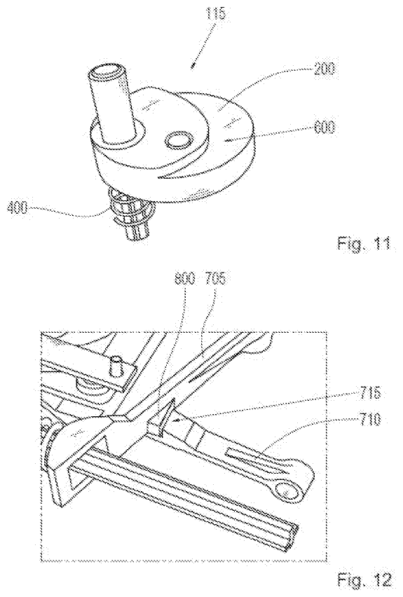

FIG. 12 shows a perspective top view of a hook device according to an exemplary embodiment;

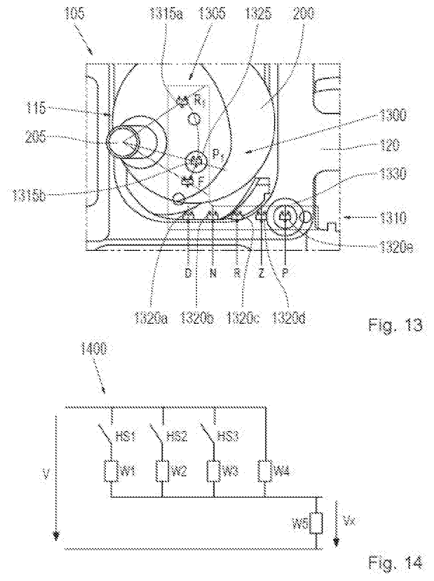

FIG. 13 shows a top view of an unlocking device with a sensor device according to an exemplary embodiment;

FIG. 14 shows a representation of a wiring of sensors according to an exemplary embodiment;

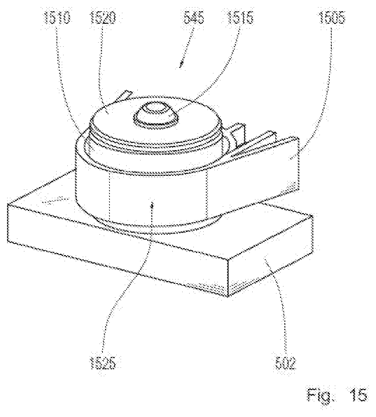

FIG. 15 shows a perspective view of a damping element according to an exemplary embodiment;

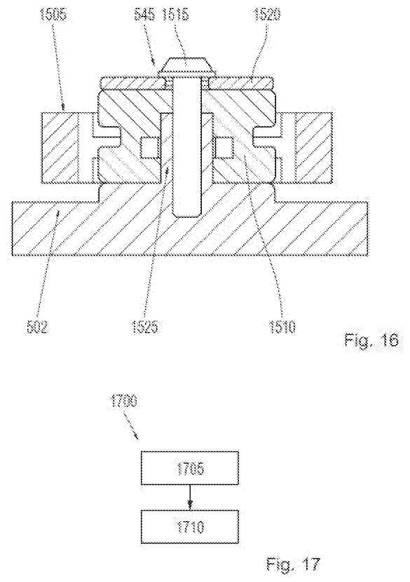

FIG. 16 shows a lateral cross-section display of a damping element according to an exemplary embodiment; and

FIG. 17 shows a flow chart of a method for operating an unlocking device according to an exemplary embodiment.

In the following description of preferred exemplary embodiments of the present approach the same or similar reference numerals are used for the elements shown in the figures and for elements with similar effect, wherein there will be no repeated description.

FIG. 1 shows a schematic representation of a vehicle 100 with an unlocking device 105 according to an exemplary embodiment. The unlocking device 105 is designed to unlock a park lock 110 of a vehicle. To this end, the unlocking device 105 comprises at least an eccentric apparatus 115, a slide unit 120 and an actuation apparatus 125.

In addition to the unlocking device 105 and the park lock 110 according to this exemplary embodiment, the vehicle 100 has furthermore at least a plurality of wheels 127, an engine 130, a vehicle transmission 135, which, according to this exemplary embodiment is designed as an automatic transmission, and a switching device 140 with a gear selector lever 145. According to this exemplary embodiment, the unlocking device 105 is part of the switching device 140, wherein the eccentric apparatus 115 and the slide unit 120 of the unlocking device 105 are accommodated in an interior of the switching device 140 and the actuation apparatus 125 is arranged on the gear selector lever 145 of the switching device 140, in order to be accessible for a driver of the vehicle 100 in the vehicle 100. According to this exemplary embodiment, a switching device motor 150 is also arranged in the interior of the switching device 140. The slide unit 120 of the unlocking device 105 is coupled to the park lock 110 via a transmission element 155 such as for example a cable and the vehicle transmission 135.

The eccentric apparatus 115 is designed to hold the slide unit 120 in a locked position in a first position accommodated at least partly in the slide unit 120, in which the park lock 110 is locked, and in a second position to enable a transferring of the slide unit 120 to an unlocking position, in which the park lock 110 is unlocked. The slide unit 120 is coupled via the transmission element 155 or the cable to the park lock 110 and is designed to position the transmission element 155 in the locking position or to position the cable in a park locking position, in order to lock or engage the park lock 110, and in the unlocking position to position the transmission element or the cable 155 in a park unlocking position, in order to unlock or disengage the park lock 110. The actuation apparatus 125 is designed to move the eccentric apparatus 115 from the first position to the second position in response to an actuation.

In the following the approach described here will be explained in greater detail:

With increasingly automated driving functions and electrified vehicles 100, electrically actuated park locks 110 will prevail. Shifting operations for gear selection of vehicle transmissions 135, previously referred to as a gear selector lever 145, are located in the interior of the vehicle 100. There are different variants of gear selector levers 145:

For manual shifting operations both the gear selection and the engagement and disengagement of the park lock 110 are realized mechanically via one or more transmission elements 155 such as linkage or cables. In the further description the approach presented here will be described with the use of a cable as a transmission element 155, although it is unequivocally obvious for a person skilled in the art that an alternative transmission element such as, for example a linkage can also be used as a transmission element 155. Shifting operations with electronic detection of the selector lever position of the gear selector lever 145 and mechanical actuation of the park lock 110, on the other hand are very common. Finally, there are fully electronic selector controls, which can be found increasingly in modern vehicles 100. Here both a position detection as well as a driver's requirement for actuation of the park lock 110 are electronically transferred to the vehicle transmission 135, or to the unlocking device 105, which can also be referred to as park lock actuator.

For vehicles 100 in which different shift control concepts are used than the aforementioned, it is necessary to depict some modularity also in the case of the unlocking device 105. For the unlocking device 105 there are various potential installation locations such as e.g. on the vehicle transmission 135, in the engine compartment or, as shown here, beneath the gear selector lever 145 arranged in the interior of the vehicle 100. According to this exemplary embodiment, an actuation of the park lock 110 then occurs via the cable 135. According to an alternative exemplary embodiment, the actuation of the park lock 110 can also occur via a linkage. For the case that the vehicle 100 has to be towed after a breakdown, it is however necessary in the case of all the above cited concepts to be able to unlock the park lock 110 currentlessly and by hand. In order, for the case of an emergency unlocking of the vehicle 100, to be able to secure the vehicle 100 via the brakes, an operation of the unlocking device 105, which can also be referred to as emergency unlocking, according to this exemplary embodiment occurs from the interior of the vehicle 100 by actuation of the actuation apparatus 125. To this end, in the case of known vehicles an additional cable is installed from the vehicle transmission in the interior of the vehicle, to which then an unlocking mechanism is connected.

In contrast to known unlocking devices, in which an emergency unlocking is installed separately in the interior, the unlocking device 105 presented here advantageously only requires a single cable 155. An actuation of the unlocking device 105 transfers vibrations and noises from the vehicle transmission 135 via the cable 155 to the interior of the vehicle 100, which can be perceived as disturbing. Since the decoupling device 105 described here has only one cable 155, these vibrations and noises advantageously only have to be decoupled once.

According to this exemplary embodiment, the unlocking device 105 is installed beneath the gear selector lever 145 in the vehicle 100. The connection to the vehicle transmission 135 and thus to the park lock 110 occurs via the cable 155. The cable connection and the unlocking device 105 are acoustically decoupled together; see FIGS. 5, 15 and 16. A transfer of the rotatory movement of the unlocking device 105 generated by the switching device motor 150 into the translatory movement of the cable 155 occurs by the eccentric apparatus 115. In other words, by means of the eccentric apparatus 115 a rotatory movement of the gearbox of the switching device motor 150 is converted to a linear movement of the slide unit 120, which can also be referred to as cable pull slide.

FIG. 2 shows a perspective view of an unlocking device 105 according to an exemplary embodiment. This can be the unlocking device 105 described on the basis of FIG. 1. The actuation apparatus belonging to the unlocking device 105 described in FIG. 1 is not shown according to this exemplary embodiment.

According to this exemplary embodiment, the eccentric apparatus 115 has a circular section 200 and an eccentric axis device 205, which extends perpendicular to a plane of the section 200. According to this exemplary embodiment, the slide unit 120 is rectangular in shape and has in essence a rectangular through opening 210 in a center, which can also be referred to as a gate opening. According to this exemplary embodiment, in the first position 215 of the eccentric apparatus 115 shown here the section 200 is completely accommodated in the slide unit 120, according to this exemplary embodiment, in the through opening 210 of the slide unit 120. The slide unit 120 is accordingly arranged in the locking position 220.

FIG. 3 shows a schematic top view of an unlocking device 105 according to an exemplary embodiment. This can be the unlocking device 105 described on the basis of FIG. 2. According to this exemplary embodiment, the slide unit 120 has an accommodation unit 300, which is designed to accommodate the cable 155.

FIG. 4 shows a lateral cross-section display device 105 according to an exemplary embodiment. This can be the unlocking device 105 described on the basis of FIG. 3.

It can be seen in FIG. 4 that the eccentric axis device 205 penetrates the section 200 and protrudes on two sides from the plane of the section 200. According to this exemplary embodiment, the unlocking device 105 has a compression spring 400 and a support spring 405. The compression spring 400 is arranged passing around a sub-section of the eccentric axis device 205 and in the first position of the eccentric apparatus shown here, is in relaxed arrangement. According to this exemplary embodiment, the section 200 is designed to execute the linear movement along the eccentric axis device 205 in the direction of the compression spring 400 in response to actuation, in order to tension the compression spring 400. According to this exemplary embodiment, the support spring 405 is arranged perpendicular to the compression spring 400 and exerts a pretensioning on the slide unit 120, as long as the section 200 is arranged in the first position. When the section 200 completely exits the through opening 210 in the direction of the compression spring 400 in response to actuation, the slide unit 120 according to this exemplary embodiment exits a lateral movement running perpendicular to the linear movement driven by the support spring 405.

In the following, details of the unlocking device 105 will be explained more precisely. The emergency unlocking of the park lock made possible by the unlocking device 105 is achieved in the following way: The unlocking process is supported by the transmission spring 405. The spring force of the transmission spring 405 is dimensioned such that it would be able to disengage the park lock. The section 200 of the eccentric apparatus is mounted axially displaceably and is held in the nominal position via the compression spring 400 arranged below, To unlock the park lock, in position “P” the section 200 of the eccentric apparatus is pressed out of the through opening 210, which can also be referred to as a gate opening, and the slide unit 120 can then shift, driven by the support spring 405. Thus, the park lock mounted on the slide unit 120 is disengaged via the cable 155. The subsequent reengagement of the park lock occurs through an initialization run of the unlocking device 105, which can be started in the workshop, or in a KL15 switch. The shifting of the eccentric axis device 205 occurs by means of a button in the form of the actuation apparatus, which is mounted acoustically decoupled on the switching device, according to this exemplary embodiment, on the gear selector lever or according to an alternative exemplary embodiment, on an adapter device shown in FIG. 5. The decoupling is achieved via an air gap to be bridged.

FIG. 5 shows a schematic cross-section display of a switching device 140 with an unlocking device 105 according to an exemplary embodiment. In the process, it can be a switching device 140 described on the basis of FIG. 1 with an unlocking device 105 described on the basis of one of FIGS. 1 to 4. The interior 500 of the switching device 140 according to this exemplary embodiment is enclosed by an adapter device 502, which has an adapter 505 and a cover 510. Between the adapter 505 and the cover 510 as well as in the region of ends of the adapter 505 the switching device 140 according to this exemplary embodiment has a plurality of seals 515. In the region of the seals 515 arranged in the region of the ends of the adapter 505 the adapter device 502 according to this exemplary embodiment has in addition a plurality of studs 520, which serve as client interfaces. The gear selector lever 145, which can also be referred to as a gearshift, according to this exemplary embodiment has a drive electronics 525. Between the drive electronics 525 and the part of the unlocking device 105 arranged in the interior 500 according to this exemplary embodiment, a flex foil 530 is arranged for contacting with the unlocking device 105, wherein the flex foil 530 to this end has sensors. The cable 155 according to this exemplary embodiment is partly sheathed by an attachment hose fitting 535. In a region in which the cable 155 and the attachment hose fitting 535 penetrate the cover 510, the switching device 140 has a sealing sleeve 540, which is arranged outside of the cover 510 contiguously on the cover 510 and which envelops the attachment hose fitting 535 in a sealing manner. According to this exemplary embodiment, two damping elements 545 are arranged between the unlocking device 105 and the cover 510, which are designed to cause an acoustic decoupling during the unlocking of the park lock.

FIG. 6 shows a top view of an unlocking device 105 according to an exemplary embodiment. Here, it can be the unlocking device 105 described on the basis of FIG. 4. According to this exemplary embodiment, the section 200 of the eccentric apparatus 115 has an offset element 600 which is designed, in response to the linear movement of the eccentric apparatus 115 to limit the lateral movement 605 of the slide unit 120 running perpendicular to the linear movement when the eccentric apparatus 115, as depicted in FIG. 9, has executed the linear movement and is arranged in the second position. To this end, the offset element 600 forms a stepped elevation of the section 200.

FIG. 7 shows a top view of an unlocking device 105 according to an exemplary embodiment. Here, it can be the unlocking device 105 described on the basis of FIG. 6, with the difference that the unlocking device 105 according to this exemplary embodiment has a transfer device 700 which is designed to transfer the slide unit 120 from the locking position 220 to the unlocking position presented in FIG. 9. The transfer device 700 has to this end the support spring 405 and according to this exemplary embodiment, additionally a lever device 705 and a hook device 710.

The support spring 405 according to this exemplary embodiment is arranged to exert a pretensioning on the lever device 705 of the transfer device 700 in the locking position 220 of the slide unit 120, wherein the support spring 405 is arranged, in response to the movement of the eccentric apparatus 115 to the second position, to release the pretensioning in order to make possible a transfer of the slide unit 120 to the unlocking position.

The lever device 705 is designed, in response to a release of the pretensioning of the support spring 405 to be turned, in order to shift the slide unit 120 to the unlocking position. To this end, the lever device 705 according to this exemplary embodiment has a nose 712, which abuts a protrusion 714 of the slide unit 120.

The hook device 710 has at least one hook 715, which in the first position of the eccentric apparatus 115 presented here is coupled to the lever device 705 such that a turning of the lever device 705 is prevented. The hook device 710 is furthermore arranged, in order to be deflected by the movement of the eccentric apparatus 115 to the second position by the eccentric apparatus 115, such that the hook 715 releases the lever device 705 and the lever device 705 driven by the support spring 405 is turned.

FIG. 7 shows an emergency unlocking via displacement. An eccentric shaft of the eccentric axis device 205 is axially displaceably mounted. When unlocking the park lock, the eccentric apparatus 115/the eccentric shaft is linearly displaced in its axial direction. The section 200 of the eccentric apparatus 115 is designed in two stages with the offset element 600. The offset element 600 serves as a travel limitation of the slide unit 120, which is actuated via the transmission spring 405, which can also be referred to as the emergency release spring and the lever device 705, which can also be referred to as a transmission lever.

FIG. 8 shows a lateral cross-section display device 105 according to an exemplary embodiment. Here, it can be the unlocking device 105 described on the basis of FIG. 7. It can be seen in FIG. 8 that the hook 715 abuts an area 800 of the lever device 705 and thus prevents the turning of the lever device 705 in the first position of the eccentric apparatus 115 in a form-fitting manner. The hook device 710 according to this exemplary embodiment has a hook device spring 805.

FIG. 9 shows a top view of an unlocking device 105 according to an exemplary embodiment. Here, it can be the unlocking device 105 described on the basis of FIG. 8, with the difference that the eccentric apparatus 115 has been moved by the actuation to the second position 900 and the slide unit 120 was then transferred to the unlocking position 905, as a result of which the park lock is unlocked. The hook 715 has been pushed away from the area 800 by the linear movement of the section 200, as a result of which the lever device 705 has been turned by the transmission spring 405 and with the nose 712, by means of a pressure on the protrusion 714, has pushed the slide unit 120 to the unlocking position 905. In the unlocking position 905 the slide unit 120 has executed the lateral movement and now abuts a side of the offset element 600 with an edge 910 of the through opening.

In other words, a drive for unlocking the park lock according to this exemplary embodiment occurs via the transmission spring 405. Here, the energy stored in the pretensioned transmission spring 405 is transferred by means of the lever device 705 to the slide unit 120. A reloading of the transmission spring 405 occurs via the engine, the transmission and the eccentric apparatus 115 or via a further mechanical system, e.g. an external lever.

FIG. 10 shows a lateral cross-section display device 105 according to an exemplary embodiment. Here, it can be the unlocking device 105 described on the basis of FIG. 9. It can be seen in FIG. 10 that the section 200 has been pushed away from the lever device 705 by means of the linear movement the hook device 710 such that the hook 715 has been moved away from the area and the turning of the lever device 705 has thus been enabled.

FIG. 11 shows a perspective representation of an eccentric apparatus 115 with an offset element 600 according to an exemplary embodiment. Here, it can be the eccentric apparatus 115 described on the basis of one of FIGS. 6 to 10.

FIG. 12 shows a perspective top view of a hook device 710 according to an exemplary embodiment. Here, it can be the hook device 710 described on the base of one of FIGS. 7 and 8, in which the hook 715 abuts the area 800 of the lever device 705 and thus in the first position of the eccentric apparatus prevents the turning of the lever device 705 in a form-fitting manner.

In a normal operation, thus, when the park lock has not been unlocked by the unlocking device, the emergency unlocking is secured in the following manner: In one of the normal operations P R N D the transmission spring 405 or the lever device 705 is secured after charging via a lock mechanism, e.g. a mechanically secured locking bolt such as the hook device 710 presented here and/or a locking lever via magnetic clamp and/or a locking magnet, as a result of which a permanent burden of engine, transmission, eccentric apparatus and slide unit 120 is prevented.

In the operations N D the eccentric apparatus is secured as follows: In position N and D the linear movement of the eccentric apparatus/of the eccentric shaft is prevented, in order to avoid an unintentional actuation of the unlocking device, e.g. through vibration loading. A support is in the process divided into three areas, a torque part, a load part and a cover.

FIG. 13 shows a top view of an unlocking device 105 with a sensor device 1300 according to an exemplary embodiment. In the process, the unlocking device 105 can be one of the unlocking devices 105 described on the basis of one of the preceding figures. The sensor device 1300 is designed to detect at least one position of the eccentric apparatus 115 arranged in the slide unit 120 or in the region of the slide unit 120. According to this exemplary embodiment, the sensor device 1300 is designed to detect a position of the eccentric apparatus 115 which represents an eccentric apparatus 115 arranged in the second position, in order to detect a park lock unlocked by the unlocking device 105. However, according to this exemplary embodiment, the eccentric apparatus 115 is arranged in the first position. The sensor device 1300 has an eccentric sensor device 1305 arranged on the eccentric apparatus 115 and a slide sensor device 1310 arranged on the slide unit 120.

According to this exemplary embodiment, the sensor device 1300 for detecting the position is designed to compare an eccentric sensor position of an eccentric sensor 1315 of the eccentric sensor device 1305 and a slide sensor position of a slide sensor 1320 of the slide sensor device 1310 in order to detect the position. According to this exemplary embodiment, the eccentric sensor device 1305 has a plurality of eccentric sensors 1315a; 1315b, which are arranged arc-shaped around the eccentric axis device 205 on the section 200 and the slide sensor device 1310 has a plurality of slide sensors 1320a; 1320b; 1320c; 1320d; 1320e, which are linearly arranged. According to this exemplary embodiment, at least one eccentric sensor position of an eccentric sensor 1315 of the eccentric sensor device 1305 is assigned to a slide sensor position of a slide sensor 1320 of the slide sensor device 1310, wherein the position is detected when the eccentric sensor position is not arranged in a predetermined relationship to the assigned slide sensor position. According to this exemplary embodiment, the eccentric sensor position of the eccentric sensor 1315a is assigned to the slide sensor position of the slide sensor 1320c, which corresponds to a gear selector lever setting of the gear selector lever in the gear R. According to this exemplary embodiment, the eccentric sensor position of the eccentric sensor 1315b is assigned to the slide sensor position of the slide sensor 1320e, which corresponds to a gear selector lever setting of the gear selector lever in the gear P. According to this exemplary embodiment, an eccentric sensor position of one of the eccentric sensors 1315 is arranged in relationship to an assigned slide sensor position of one of the slide sensors 1320, the position according to this exemplary embodiment is thus not detected by the sensor device 1300.

According to this exemplary embodiment, the eccentric sensors 1315a; 1315b and the slide sensors 1320a; 1320b; 1320c; 1320d; 1320e; are at least partly designed as magnetic sensors. According to an alternative exemplary embodiment, at least one of the eccentric sensors 1315 and/or one of the slide sensors 1320 is at least partly designed as a magnetic sensor. For detection of the at least one assigned position the eccentric sensor device 1305 has an eccentric magnet 1325 and the slide sensor device 1310 has a slide magnet 1330.

In the sensor concept presented here there are damping elements for the sensors in the form of the slide sensor device 1310 and of the eccentric sensor device 1305 both on the slide unit 120 and on the eccentric apparatus 115.

Redundancy for position P and R: The emergency function according to this exemplary embodiment is detected by the eccentric sensors 1315 on the eccentric apparatus 115, when there is no signal. The normal function is detected by the eccentric sensors 1315/the sensor R1 on the eccentric apparatus 115. A spring-position F is for switching off the engine in a process “tension spring”

FIG. 14 shows a representation of a wiring 1400 of sensors according to an exemplary embodiment. This can be a wiring 1400 of the slide sensors and eccentric sensors described on the basis of FIG. 13.

FIG. 15 shows a perspective view of a damping element 545 according to an exemplary embodiment. This can be the damping element 545 described in FIG. 5. The damping element 545 is designed to acoustically dampen at least one noise of an unlocking device described on the basis of FIG. 1 to 10 or 13 when unlocking the park lock. The damping element 545 according to this exemplary embodiment is part of the unlocking device and is arranged between a housing 1505 of the unlocking device and the adapter device 502 of the switching device described in FIG. 5. The damping element 545 according to this exemplary embodiment has a damping body 1510 with an opening, a self-tapping screw 1515 and a washer 1520.

The opening accommodates a dome 1525 of the adapter device 502. The self-tapping screw 1515 is screwed into the dome 1525 of the adapter device 502, in order to fix the housing 1505 of the unlocking device on the adapter device 502. According to this exemplary embodiment, the damping element 545 is accommodated in an annular housing section of the housing 1505.

The damping element 545 enables an acoustic encapsulation under a base plate in the module. The unlocking device is located beneath the base plate in the adapter device 502 and is acoustically decoupled, in order to prevent a generation of noise. The decoupling occurs via the or a plurality of damping elements 545, which prevent a vibration transmission between the unlocking device and the adapter device 502. In contrast to known unlocking devices, the damping element 545 presented here advantageously uses a self-tapping screw 1515 for plastic. This is screwed into an injection molded dome 1525, which is located on the adapter device 502, which screws into the unlocking device.

FIG. 16 shows a lateral cross-section display of a damping element 545 according to an exemplary embodiment. This can be a damping element 545 described on the basis of FIG. 15.

FIG. 17 shows a flow chart of a method 1700 for operating an unlocking device according to an exemplary embodiment. This can be a method 1700 for operating one of the unlocking devices described on the basis of one of FIG. 1 to 10 or 13. The method 1700 has at least one step 1705 of movement and one step 1710 of transfer. In step 1705 of movement the eccentric apparatus is moved from the first position to the second position in response to the actuation of the actuation apparatus. In step 1710 of transfer the slide unit is transferred from the locking position to the unlocking position in response to step 1705 of movement, in order to unlock the park lock.

The exemplary embodiments described and shown in the figures are only selected by way of example. Different exemplary embodiments can be combined with one another completely or in relation to individual features. An exemplary embodiment can also be amended by the features of a further exemplary embodiment.

Further, steps of a method according to the invention can be repeated as well as executed in a sequence different than the described sequence.

If an exemplary embodiment comprises an “and/or” link between a first feature and a second feature, this can be read in such a way that the exemplary embodiment according to one embodiment has both the first feature and the second feature and according to a further embodiment has either only the first feature or only the second feature.

### REFERENCE NUMERALS

100 vehicle

105 unlocking device

110 park lock

115 eccentric apparatus

120 slide unit

125 actuation apparatus

127 wheel

130 engine

135 vehicle transmission

140 switching device

145 gear selector lever

150 switching device motor

155 transmission means, cable

200 section

205 eccentric axis device

210 through opening

215 first position

220 locking position

300 accommodation unit

400 compression spring

405 support spring

500 interior

502 adapter device

505 adapter

510 cover

515 seal

520 studs

525 drive electronics

530 flex foil

535 attachment hose fitting

540 sealing sleeve

545 damping element

600 offset element

605 lateral movement

700 transfer device

705 lever device

710 hook device

712 nose

714 protrusion

715 hook

800 area

805 hook device spring

900 second position

905 unlocking position

910 edge

1300 sensor device

1305 eccentric sensor device

1310 slide sensor device

1315 eccentric sensor

1315a eccentric sensor

1315b eccentric sensor

1320 slide sensor

1320a slide sensor

1320b slide sensor

1320c slide sensor

1320d slide sensor

1320e slide sensor

1325 eccentric magnet

1330 slide magnet

1400 wiring

1505 housing

1510 damping body

1515 self-tapping screw

1520 washer

1525 dome

1700 method

1705 step of movement

1710 step of transfer

1. An unlocking device for unlocking a park lock of a vehicle, wherein the unlocking device comprises at least the following features:
an eccentric apparatus, which is designed to hold the slide unit in a locking position in a first position accommodated at least partly in a slide unit, in which the park lock is locked or engaged and in a second position to enable a transferring of the slide unit to an unlocking position, in which the park lock is unlocked or disengaged;
the slide unit, which is or can be coupled via a transmission to the park lock, wherein in the locking position the slide unit is designed to position the transmission means in a park locking position in order to lock the park lock and in the unlocking position to position the transmission in a park unlocking position, in order to unlock the park lock; and
an actuation apparatus, which is designed to move the eccentric apparatus from the first position to the second position in response to an actuation.

2. The unlocking device according to claim 1, in which a section of the eccentric apparatus accommodated in the slide unit is designed to execute a linear movement along an eccentric axis device of the eccentric apparatus in response to actuation.

3. The unlocking device according to claim 2, in which the section of the eccentric apparatus has an offset element, which is designed to limit a lateral movement of the slide unit running perpendicular to the linear movement in response to the linear movement of the eccentric apparatus.

4. The unlocking device according to claim 1, in which the eccentric apparatus has at least one compression spring which is relaxed in the first position of the eccentric apparatus and which is arranged to be tensioned by at least one component of the eccentric apparatus in response to actuation.

5. The unlocking device according to claim 1, with a transfer device which is designed to transfer the slide unit from the locking position to the unlocking position, wherein the transfer device has at least one support spring, which is arranged to exert a pretensioning on the slide unit and/or a lever device of the transfer device in the locking position of the slide unit, wherein the support spring is arranged to release the pretensioning, in order to enable a transfer of the slide unit to the unlocking position in response to the movement of the eccentric apparatus to the second position.

6. The unlocking device according to claim 5, in which the transfer device has at least the lever device, which is designed to be turned in response to a release of the pretensioning of the support spring, in order to shift the slide unit to the unlocking position.

7. The unlocking device according to claim 5, in which the transfer device has at least one hook device with at least one hook, which is coupled to the lever device in the first position of the eccentric apparatus such that a turning of the lever device is prevented, wherein the hook device is arranged through the movement of the eccentric apparatus to the second position to be deflected by the eccentric apparatus such that the hook releases the lever device and the lever device is turned when driven by the support springer.

8. The unlocking device according to claim 1, with a sensor device, having at least one eccentric sensor device arranged on the eccentric apparatus and/or a slide sensor device arranged on the slide unit, wherein the sensor device is designed to detect at least one position of the eccentric apparatus accommodated in the slide unit or arranged in the region of the slide unit.

9. The unlocking device according to claim 8, in which the sensor device is designed to compare an eccentric sensor position of an eccentric sensor of the eccentric sensor device and/or a slide sensor position of a slide sensor of the slide sensor device in order to detect the position.

10. The unlocking device according to claim 8, in which the eccentric sensor device has a plurality of eccentric sensors which are arranged arc-shaped and/or the slide sensor device has a plurality of slide sensors which are linearly arranged.

11. The unlocking device according to claim 8, in which at least one eccentric sensor position of an eccentric sensor of the eccentric sensor device is assigned to a slide sensor position of a slide sensor of the slide sensor device, in particular, wherein the position is detected when the eccentric sensor position is not arranged in a predetermined relationship to the assigned slide sensor position.

12. The unlocking device according to claim 8, in which at least one eccentric sensor of the eccentric sensor device and/or a slide sensor of the slide sensor device is at least partly designed as a magnetic sensor.

13. The unlocking device according claim 1, with at least one damping element that is designed to acoustically dampen at least one noise of the unlocking device when unlocking the park lock, wherein the damping element has at least one opening, which is designed in order to accommodate a dome of an adapter device, wherein the damping element has at least one self-tapping screw, which is designed to be screwed into the dome of the adapter device in order to fix the unlocking device on the adapter device when the damping element is accommodated by the dome.

14. A method for operating an unlocking device according to any of claims 1 to 13, wherein the method comprises at least the following steps:
moving the eccentric apparatus from the first position to the second position in response to the actuation of the actuation apparatus; and
transferring the slide unit from the locking position to the unlocking position in response to a step of movement in order to unlock the park lock.

15. The unlocking device of claim 1, wherein the transmission is a cable.
